(19) United States
(12) Patent Application Publication
(10) Pub. No.: US 2024/0347291 A1
(43) Pub. Date: Oct. 17, 2024

(54) Static and movable plate assembly of key switch

(71) Applicant: DONGGUAN CITY KAIHUA ELECTRONICS CO., LTD, Dongguan, Guangdong (CN)

(72) Inventors: FuXi Wu, Dongguan, Guangdong (CN); Qiancheng Hu, Dongguan, Guangdong (CN)

(21) Appl. No.: 18/293,724

(22) PCT Filed: Aug. 4, 2022
(86) PCT No.: PCT/CN2022/110164

§ 371 Date: Jan. 30, 2024

(30) Foreign Application Priority Data
Aug. 17, 2021 (CN) 202121924107.7

(51) Int. Cl. H01H 13/20; H01H 13/14

(52) U.S. Cl. CPC H01H 13/20; H01H 13/14

(57) ABSTRACT

The present utility model discloses a static and movable plate assembly of a key switch, comprising a static plate and a movable plate, wherein the movable plate and the static plate are contacted or separated under the push of an external force: the movable plate comprises a support arm of the movable plate which is integrally formed and bent twice to the outside of the side; It has a simple structure and reduces the production cost.

### TECHNICAL FIELD

The present utility model relates to the technical field of key switches, and particularly relates to a static and movable plate assembly of a key switch.

### BACKGROUND ART

At present, the common key switches in the market mainly include components, such as a base, an upper cover, a static plate, a movable plate and a button plate. An accommodating cavity is formed by the upper cover and the base. The movable plate and the static plate are arranged in the accommodating cavity. The elastic portions on the movable plate and the static plate extend downwards until contacting the external circuit board, so as to achieve the electrical connection with the external circuit board. Since the elastic portions of the movable plate and the static plate require space to be extended downwards, a common key switch is generally made higher in order to reserve the space, which is not applicable to some ultra-thin keyboards and some industrial equipment. Also, the common movable and static plate structure in the market has a complicated structure and high production cost.

### Summary of the Utility Model

In view of the above-mentioned deficiencies, the present utility model aims to provide a static and movable plate assembly of a key switch, which can conduct an external circuit from the side, reduce the overall height, and implement an ultra-thin product. It has a simple structure and reduces the production cost.

The technical solutions adopted by the utility model to achieve the above-mentioned purpose are as follows.

A static and movable plate assembly of a key switch comprises a static plate and a movable plate, wherein the movable plate and the static plate are contacted or separated under the push of an external force, and the movable plate comprises a support arm of the movable plate which is integrally formed and bent twice to the outside of the side; the static plate comprises a support arm of the static plate which is integrally formed and bent twice to the outside of the side; wherein the support arm of the movable plate is provided with a first bent portion of the movable plate externally bent to the outside of the side, the first bent portion of the movable plate being electrically connected to an external circuit; and the support arm of the static plate is provided with a first bent portion of the static plate externally bent to the outside of the side, the first bent portion of the static plate being electrically connected to an external circuit.

Further, the support arm of the movable plate is provided with a second bent portion of the movable plate which bends downwards and extends upwards, wherein the first bent portion of the movable plate is provided on the second bent portion of the movable plate.

Further, the support arm of the static plate is provided with a second bent portion of the static plate which bends downwards and extends upwards, wherein the first bent portion of the static plate is provided on the second bent portion of the static plate.

Further, the movable plate is provided with an integrally formed fixing portion of the movable plate, a contact portion of the movable plate connected to one end of the fixing portion of the movable plate, and a pushing portion of the movable plate connected to the contact portion of the movable plate, wherein the support arm of the movable plate is provided at the other end of the fixing portion of the movable plate.

Further, the static plate is provided with an integrally formed fixing portion of the static plate, and a contact portion of the static plate connected to one end of the fixing portion of the static plate and matched with the contact portion of the movable plate.

Further, at least one contact projection of the movable plate is provided at one end of the contact portion of the movable plate close to the pushing portion of the movable plate; at least one contact projection of the static plate matched with the contact projection of the movable plate is provided at one end of the contact portion of the static plate close to the pushing portion of the movable plate; wherein the contact or separation between the contact projection of the movable plate and the contact projection of the static plate is controlled by the movement of the pushing portion of the movable plate in the left-right direction.

Further, the contact projection of the movable plate is in a laterally disposed semi-cylindrical shape.

Further, the contact projection of the static plate is in a longitudinally disposed semi-cylindrical shape.

Further, the pushing portion of the movable plate is bent in the direction of the contact portion of the static plate.

Further, the contact portion of the static plate is bent in the direction of the contact portion of the movable plate.

The beneficial effects of the utility model are as follows.
(1) By providing a support arm of the movable plate, a first bent portion of the movable plate externally bent to the outside of the side is provided thereon, and the first bent portion of the movable plate is electrically connected to an external circuit, so as to realize the conduction of the movable plate to the external circuit from the side, reduce the overall height of the movable plate, and implement a light and thin movable plate. By providing a support arm of the static plate, a first bent portion of the static plate externally bent to the outside of the side is provided thereon, and the first bent portion of the static plate is electrically connected to an external circuit, so as to realize the conduction of the static plate to the external circuit from the side, reduce the overall height of the static plate, and implement a light and thin static plate. The combination of the movable plate and the static plate enables the product to conduct an external circuit from the side, reduces the overall height, implements an ultra-thin product. It has a simple structure and reduces the production cost.
(2) At least one contact projection of the movable plate is provided on the contact portion of the movable plate, and the contact projection of the movable plate is in a laterally disposed semi-cylindrical shape. At least one contact portion of the static plate is provided on the contact portion of the static plate, and the contact portion of the static plate is in a longitudinally disposed semi-cylindrical shape, so that the lateral and longitudinal arrangements extend the contact range of the contact projection of the static plate and the contact projection of the movable plate, and improve the contact efficiency of the movable plate and the static plate, thereby further improving the contact matching degree of the present assembly and improving the working efficiency of the present assembly.
(3) By providing a pushing portion of the movable plate, the pushing portion of the movable plate is bent to the contact portion of the static plate, and the bent portion allows the power pushing portion to be better pushed by an external force, so as to more quickly drive the contact of movable plate to contact or separate from the contact portion of the static plate, thereby improving the efficiency the movable plate to contact or separate from the static plate.
(4) By respectively providing a movable plate and a static plate, the movable plate and the static plate can be disassembled and replaced separately, thereby reducing the replacement cost and effectively improving the service life of the static and movable plate assembly.

The above is an overview of the technical solution of the utility model, and the utility model is further described below in conjunction with the drawings and the specific embodiments.

### BRIEF DESCRIPTION OF THE DRAWINGS

FIG. 1 is a structurally schematic diagram of the present utility model;

FIG. 2 is a top view of the present utility model;

FIG. 3 is a structurally schematic diagram of a movable plate;

FIG. 4 is a structurally schematic diagram of a static plate;

FIG. 5 is a structurally schematic diagram of a static and movable plate assembly in a key switch;

FIG. 6 is a structurally schematic diagram in which the static and movable plate assembly is connected to an external circuit in the key switch;

In the drawings, 1, static plate; 11, support arm of static plate; 111, first bent portion of static plate; 112, second bent portion of static plate; 12, fixing portion of static plate; 13, contact portion of static plate; 131, contact projection of static plate; 2, movable plate; 21, support arm of movable plate; 211, first bent portion of movable plate; 212, second bent portion of movable plate; 22, fixing portion of movable plate; 23, contact portion of movable plate; 231, contact projection of movable plate; 24, pushing portion of movable plate; 3, key switch.

### DETAILED DESCRIPTION

In order to further clarify the technical means and effects adopted by the present utility model to achieve the intended purpose, the specific embodiments of the present utility model will be described in detail below with reference to the accompanying drawings and preferred embodiments.

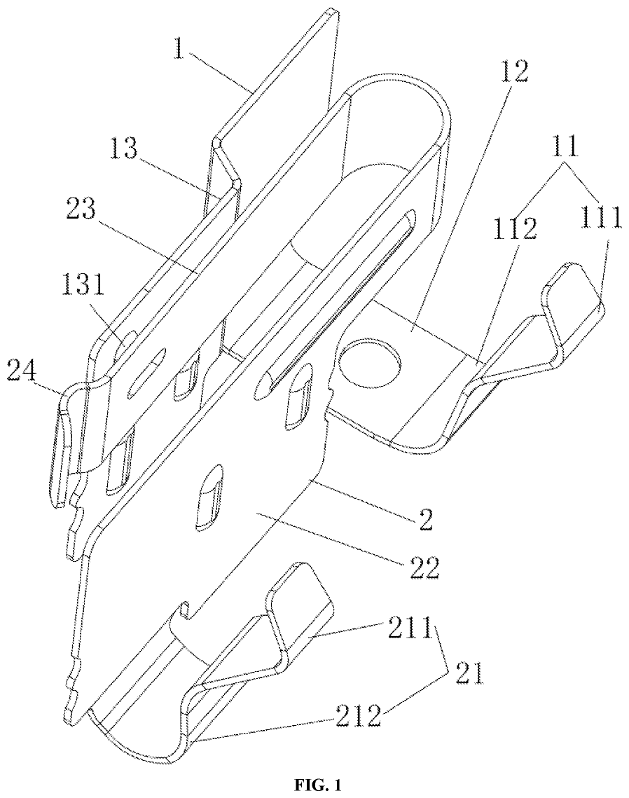

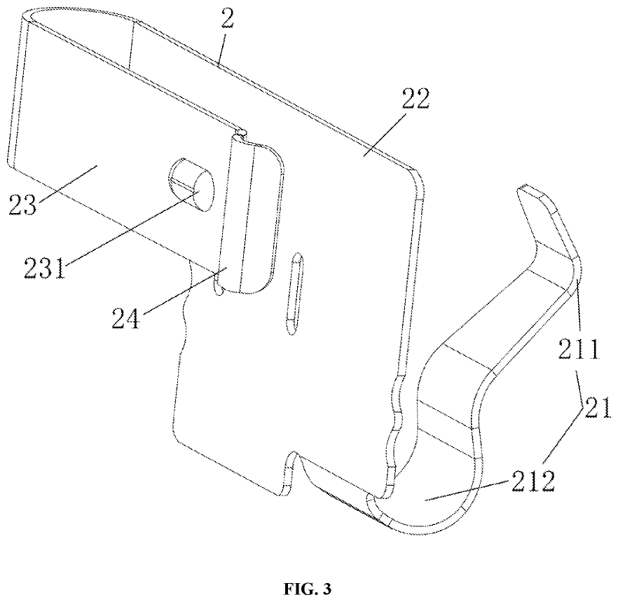

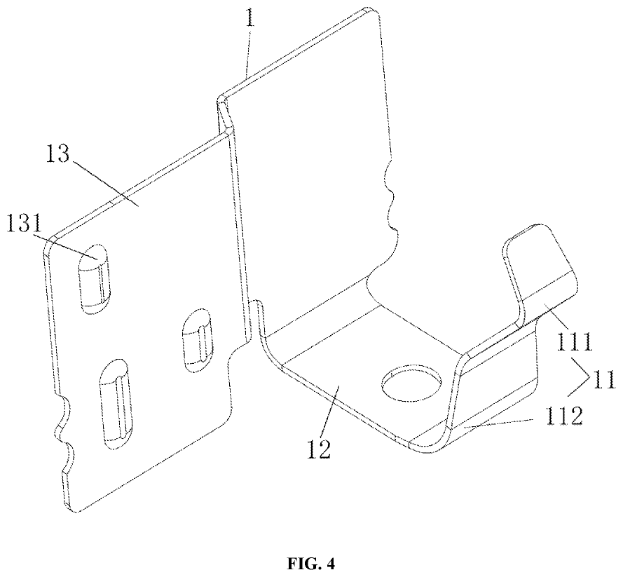

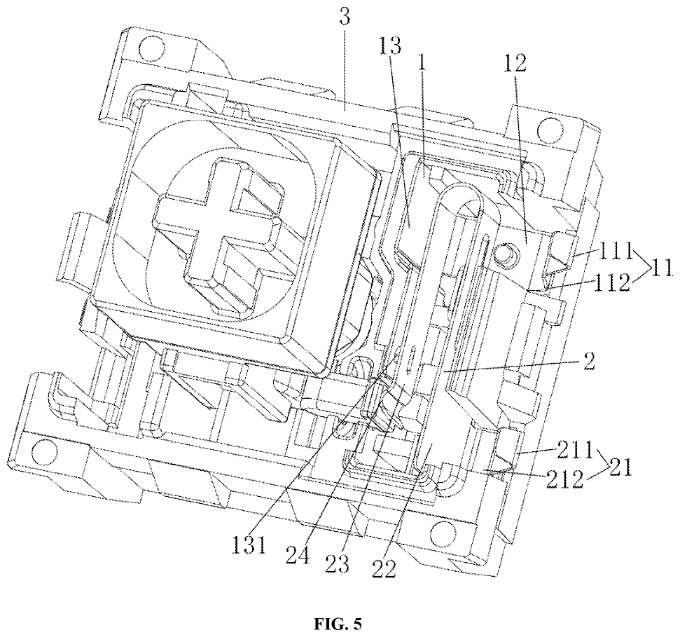

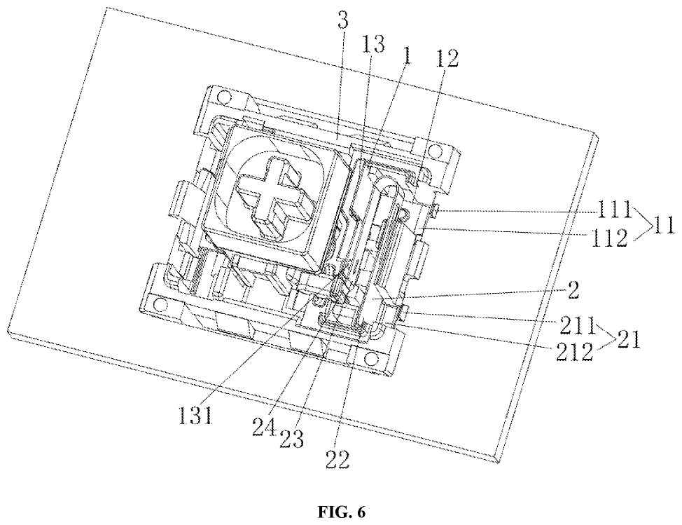

With reference to FIG. 1 to FIG. 6, the embodiment of the present utility model provides a static and movable plate assembly of a key switch 3, including a static plate 1 and a movable plate 2, wherein the movable plate 2 and the static plate 1 are contacted or separated under the push of an external force, and the movable plate 2 includes a support arm 21 of the movable plate which is integrally formed and bent twice to the outside of the side. The static plate 1 includes a support arm 11 of the static plate which is integrally formed and bent twice to the outside of the side. The support arm 21 of the movable plate is provided with a first bent portion 211 of the movable plate externally bent to the outside of the side, the first bent portion 211 of the movable plate being electrically connected to an external circuit. The support arm 11 of the static plate is provided with a first bent portion 111 of the static plate externally bent to the outside of the side, the first bent portion 111 of the static plate being electrically connected to an external circuit.

By providing a support arm 21 of the movable plate, a first bent portion 211 of the movable plate externally bent to the outside of the side is provided thereon, and the first bent portion 211 of the movable plate is electrically connected to an external circuit, so as to realize the conduction of the movable plate 2 to the external circuit from the side, reduce the overall height of the movable plate 2, and implement a light and thin movable plate 2. By providing a support arm 11 of the static plate, a first bent portion 111 of the static plate externally bent to the outside of the side is provided thereon, and the first bent portion 111 of the static plate is electrically connected to an external circuit, so as to realize the conduction of the static plate 1 to the external circuit from the side, reduce the overall height of the static plate 1, and implement a light and thin static plate 1. The combination of the movable plate 2 and the static plate 1 enables the product to conduct an external circuit from the side, reduces the overall height, implement an ultra-thin product. It has a simple structure and reduces the production cost.

With regard to the specific structure of the support arm 21 of the movable plate, as shown in FIG. 1 to FIG. 3 and FIG. 5 to FIG. 6, the support arm 21 of the movable plate is further provided with a second bent portion 212 of the movable plate which bends downwards and extends upwards, and the first bent portion 211 of the movable plate is provided on the second bent portion 212 of the movable plate. Preferably, the second bent portion 212 of the movable plate is bent downwards in a U-shape, and the bending height is relatively low. By providing the second bent portion 212 of the movable plate which bends downwards and extends upwards, the first bent portion 211 of the movable plate which is provided on the second bent portion 212 of the movable plate and extends to the side is matched, so that the support arm 21 of the movable plate better extends to the side, so as to realize the conduction of movable plate 2 to an external circuit from the side, and reduce the overall height of the movable plate 2, thereby implementing a light and thin movable plate 2.

With regard to the specific structure of the support arm 11 of the static plate, as shown in FIG. 1 to FIG. 2 and FIG. 4 to FIG. 6, the support arm 11 of the static plate is further provided with a second bent portion 112 of the static plate which bends downwards and extends upwards, and the first bent portion 111 of the static plate is provided on the second bent portion 112 of the static plate. Preferably, the second bent portion 112 of the static plate is bent downwards in a U-shape with a wider bottom and a lower bending height. By providing the second bent portion 112 of the static plate which bends downward and extends upwards, the first bent portion 111 of the static plate which is provided on the second bent portion 112 of the static plate and extends to the side is matched, so that the support arm 11 of the static plate better extends to the side, so as to realize the conduction of the static plate 1 to an external circuit from the side, and reduce the overall height of the static plate 1, thereby implementing a light and thin static plate 1. In addition, the bottom of the second bent portion 112 of the static plate is wider, which effectively prevents an erroneous contact with the movable plate 2, thereby ensuring the conduction accuracy of the present assembly.

With regard to the specific structure of the movable plate 2, as shown in FIG. 1 to FIG. 3 and FIG. 5 to FIG. 6, the movable plate 2 is further provided with an integrally formed fixing portion 22 of the movable plate, a contact portion 23 of the movable plate connected to one end of the fixing portion 22 of the movable plate, and a pushing portion 24 of the movable plate connected to the contact portion 23 of the movable plate. The support arm 21 of the movable plate is provided at the other end of the fixing portion 22 of the movable plate. The movable plate 2 is fixed on the key switch 3 via a fixing portion 22 of the movable plate, and the pushing portion 24 of the movable plate, under the control of the key switch 3, realizes the contact or separation of the contact portion 23 of the movable plate and the contact portion 13 of the static plate described below, thereby achieving the conduction or non-conduction purpose of the present assembly. Specifically, when the pushing portion 24 of the movable plate receives a pushing force in the direction of the support arm 21 of the movable plate given by the key switch 3, the pushing portion 24 of the movable plate drives the contact portion 23 of the movable plate connected thereto to move in the direction of the support arm 21 of the movable plate. At the same time, the contact portion 23 of the movable plate is separated from the contact portion 13 of the static plate described below, thereby achieving the non-conduction purpose of the movable plate 2 and the static plate 1. When the pushing force is not given by the key switch 3, the contact portion 23 of the movable plate moves in the direction of the below-mentioned contact portion 13 of the static plate under the elastic restoring force of the movable plate 2 itself, and achieves contact with the below-mentioned contact portion 13 of the static plate, thereby achieving the conduction between the movable plate 2 and the static plate 1, further achieving the on/off safety of the present assembly and improving the conduction efficiency.

By providing a movable plate 2 and a static plate 1 respectively, the movable plate 2 and the static plate 1 may be separately disassembled and replaced, thereby reducing the replacement cost, and effectively prolonging the service life of the static and movable plate assembly.

Preferably, the contact portion 23 of the movable plate is far away from the fixing portion 12 of the static plate and is in a laterally U-shape, so as to prevent the contact portion 23 of the movable plate from the erroneous contact with the fixing portion 12 of the static plate. The fixing portion 22 of the movable plate is far away from the fixing portion 12 of the static plate and is in a longitudinal plate shape, so as to prevent the fixing portion 22 of the movable plate from the erroneous contact with the fixing portion 12 of the static plate.

In order to allow the pushing portion 24 of the movable plate to better receive the pushing force of the key switch 3, as shown in FIG. 1 to FIG. 3 and FIG. 5, the pushing portion 24 of the movable plate is bent in the direction of the contact portion 13 of the static plate. By bending the pushing portion 24 of the movable plate in the direction of the contact portion 13 of the static plate, the bent portion makes the pushing portion 24 of the movable plate better contact with the pushing component of the key switch 3, thereby improving the matching degree between the pushing component on the key switch 3 and the pushing portion 24 of the movable plate, improving the pushing accuracy of the pushing portion 24 of the movable plate, and further improving the working efficiency of the present assembly.

With regard to the specific structure of the static plate 1, as shown in FIG. 1 to FIG. 2 and FIG. 4 to FIG. 6, the static plate 1 is further provided with an integrally formed fixing portion 12 of the static plate, and a contact portion 13 of the static plate connected to one end of the fixing portion 12 of the static plate and matched with the contact portion 23 of the movable plate. The static plate 1 is fixed on the key switch 3 via the fixing portion 12 of the static plate, and the contact portion 13 of the static plate connected to the fixing portion 12 of the static plate is fixed on the key switch 3 at the same time, thereby ensuring that the contact portion 13 of the static plate is not easy to move or fall off during use, reducing the erroneous contact between the contact portion 13 of the static plate and the contact portion 23 of the movable plate, and ensuring the normal conduction and disconnection of the present assembly.

In order to better conduct the contact portion 23 of the movable plate and the contact portion 13 of the static plate, as shown in FIG. 1 to FIG. 2 and FIG. 4, the contact portion 13 of the static plate bends in the direction of the contact portion 23 of the movable plate, thereby reducing the distance between the contact portion 13 of the static plate and the contact portion 23 of the movable plate, enabling the contact portion 13 of the static plate and the contact portion 23 of the movable plate to conduct more quickly when the conduction is needed, and further improving the conduction speed and conduction efficiency of the present assembly.

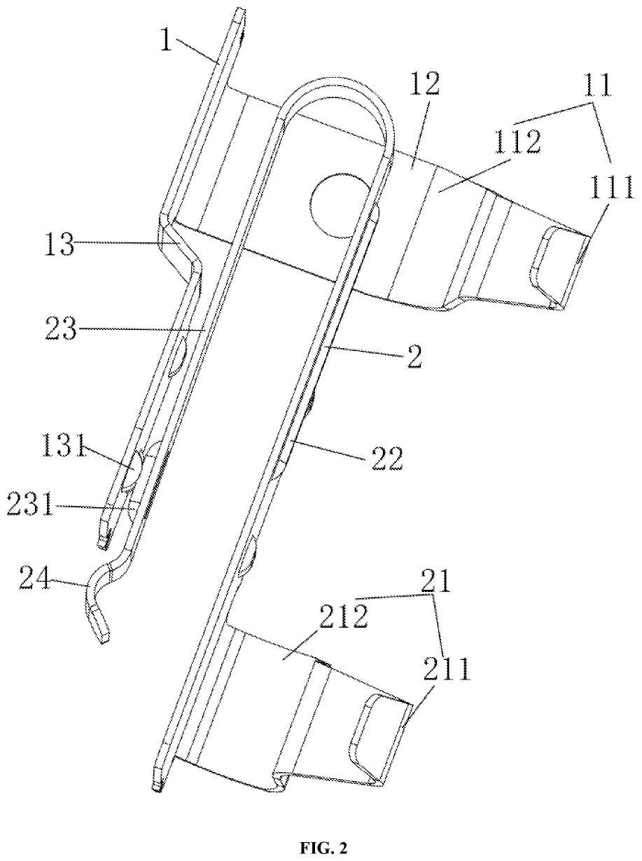

With regard to the specific contact mode between the contact portion 23 of the movable plate and the contact portion 13 of the static plate, as shown in FIG. 1 to FIG. 2, at least one contact projection 231 of the movable plate is provided at one end of the contact portion 23 of the movable plate close to the pushing portion 24 of the movable plate. At least one contact projection 131 of the static plate matched with the contact projection 231 of the movable plate is provided at one end of the contact portion 13 of the static plate close to the pushing portion 24 of the movable plate. The contact and separation between the contact projection 231 of the movable plate and the contact projection 131 of the static plate are controlled by the movement of the pushing portion 24 of the movable plate in the left-right direction. By providing a contact projection 231 of the movable plate and a contact projection 131 of the static plate for contact and conduction, the risk of erroneous contact at other positions of the contact portion 23 of the movable plate and the contact portion 13 of the static plate is reduced, and the two projections are oppositely arranged, thereby reducing the conduction distance, further improving the conduction speed and improving the conduction efficiency.

Preferably, as shown in FIG. 1 to FIG. 2, the contact projection 231 of the movable plate is in a laterally disposed semi-cylindrical shape, and the contact projection 131 of the static plate is in a longitudinally disposed semi-cylindrical shape. The lateral and longitudinal designs extend the contact range of the contact projection 131 of the static plate and the contact projection 231 of the movable plate, and improve the contact efficiency of the movable plate and the static plate, thereby further improving the contact matching degree of the present assembly and improving the working efficiency of the present assembly.

The above is merely preferred embodiments of the present utility model and do not limit the technical scope of the present utility model. Therefore, other structures obtained by adopting the same or similar technical features as the above embodiments of the present utility model are all within the protection scope of the present utility model.

1. A static and movable plate assembly of a key switch, comprising a static plate and a movable plate, wherein the movable plate and the static plate are contacted or separated under the push of an external force, wherein the movable plate comprises a support arm of the movable plate which is integrally formed and bent twice to the outside of the side; the static plate comprises a support arm of the static plate which is integrally formed and bent twice to the outside of the side; wherein the support arm of the movable plate is provided with a first bent portion of the movable plate externally bent to the outside of the side, the first bent portion of the movable plate being electrically connected to an external circuit; and the support arm of the static plate is provided with a first bent portion of the static plate externally bent to the outside of the side, the first bent portion of the static plate being electrically connected to an external circuit.

2. The static and movable plate assembly of the key switch according to claim 1, wherein the support arm of the movable plate is further provided with a second bent portion of the movable plate which bends downwards and extends upwards, wherein the first bent portion of the movable plate is provided on the second bent portion of the movable plate.

3. The static and movable plate assembly of the key switch according to claim 1, wherein the support arm of the static plate is further provided with a second bent portion of the static plate which bends downwards and extends upwards, wherein the first bent portion of the static plate is provided on the second bent portion of the static plate.

4. The static and movable plate assembly of the key switch according to claim 1, wherein the movable plate is further provided with an integrally formed fixing portion of the movable plate, a contact portion of the movable plate connected to one end of the fixing portion of the movable plate, and a pushing portion of the movable plate connected to the contact portion of the movable plate, wherein the support arm of the movable plate is provided at the other end of the fixing portion of the movable plate.

5. The static and movable plate assembly of the key switch according to claim 4, wherein the static plate is further provided with an integrally formed fixing portion of the static plate, and a contact portion of the static plate connected to one end of the fixing portion of the static plate and matched with the contact portion of the movable plate.

6. The static and movable plate assembly of the key switch according to claim 5, wherein at least one contact projection of the movable plate is provided at one end of the contact portion of the movable plate close to the pushing portion of the movable plate; at least one contact projection of the static plate matched with the contact projection of the movable plate is provided at one end of the contact portion of the static plate close to the pushing portion of the movable plate; wherein the contact or separation between the contact projection of the movable plate and the contact projection of the static plate is controlled by the movement of the pushing portion of the movable plate in the left-right direction.

7. The static and movable plate assembly of the key switch according to claim 6, wherein the contact projection of the movable plate is in a laterally disposed semi-cylindrical shape.

8. The static and movable plate assembly of the key switch according to claim 6, wherein the contact projection of the static plate is in a longitudinally disposed semi-cylindrical shape.

9. The static and movable plate assembly of the key switch according to claim 5, wherein the pushing portion of the movable plate is bent in the direction of the contact portion of the static plate.

10. The static and movable plate assembly of the key switch according to claim 5, wherein the contact portion of the static plate is bent in the direction of the contact portion of the movable plate.
